(19) United States
(12) Patent Application Publication
(10) Pub. No.: US 2008/0305458 A1
(43) Pub. Date: Dec. 11, 2008

(54) METHOD AND APPARATUS FOR COMBINING A NON RADIOGRAHPIC IMAGE WITH AN XRAY OR MRI IMAGE IN THREE DIMENSIONS TO OBTAIN ACCURACY OF AN INTRA ORAL SCAN AND ROOT POSITION

(76) Inventor: Marc S. Lemchen, New York, NY (US)

Correspondence Address: Law Offices of Daniel L. Dawes, 5200 Warner Blvd, Ste. 106, Huntington Beach, CA, 92649, US

(21) Appl. No.: 12/129,511

(22) Filed: May 29, 2008

Related U.S. Application Data
(60) Provisional application No. 60/942,160, filed on Jun. 5, 2007.

(51) Int. Cl. A61C 5/10

(52) U.S. Cl. 433/223

(57) ABSTRACT

A method includes the steps of: generating a three dimensional intra-oral image of the crown of a tooth or crowns of a plurality of selected teeth; generating a three dimensional image of the root of the corresponding tooth or roots of the corresponding selected teeth; and compositing the three dimensional images of the crown(s) and root(s) of the tooth to produce a composite image. An apparatus comprises means for performing each the foregoing steps. A computer-readable storage medium includes instructions for controlling a computer system to perform each of the steps.

### RELATED APPLICATIONS

The present application is related to U.S. Provisional Patent Application, Ser. No. 60/942,160, filed on Jun. 5, 2007, which is incorporated herein by reference and to which priority is claimed pursuant to 35 USC 119.

### BACKGROUND OF THE INVENTION

1. Field of the Invention

The invention relates to the field of intra-oral scanning using light, laser, video, sound or any other nonradiographic method and combining such scans with a three dimensional x-ray based scan or MRI.

2. Description of the Prior Art

Imagine a plaster model of the teeth. The practitioner does not really know where the roots of the teeth are from the plaster model and actually practitioner does not even know when he or she looks into the patient's mouth. The practitioner tries to extrapolate the root position when he or she constructs or places orthodontic appliances based on a best guess. The practitioner does not know when, or if, x-ray scans will be accurate enough to construct a three dimension model to make the appliances in either virtual or hard copies due to the need to keep the patient still, the level of the dose of radiation to achieve high resolution or accuracy, and the interference with the image from metal restorations or braces which may be already in place.

Unitek spent $95 million to design a scanning device, but root positions are still extrapolated based on best guesses from inaccurate x-rays. The dimensional accuracy of the root position is not as critical in the construction of the appliance. The practitioner needs a vector direction for the root to tell him or her where to put the brace or wire to place the root in the right position relative to the crown of the tooth and the bone in which it is embedded.

### BRIEF SUMMARY OF THE INVENTION

The illustrated embodiment of the invention includes a method comprising the steps of: generating a first three dimensional intra-oral image of the crown of a tooth or crowns of a plurality of selected teeth; generating a second three dimensional image of the root of the corresponding tooth or roots of the corresponding selected teeth; and compositing the first and second three dimensional images of the crown and root of the tooth or crowns and roots of the plurality of selected teeth to produce a composite image.

The step of generating the first three dimensional intra-oral image of the crown of the tooth or crowns of the plurality of selected teeth comprises the step of generating a first three dimensional intra-oral image using optical scanning, laser scanning, video scanning of crown of the tooth or crowns of the plurality of selected teeth.

In another embodiment the step of generating the first three dimensional intra-oral image of the crown of the tooth or crowns of the plurality of selected teeth comprises the step of nonradiographically scanning the crown of the tooth or crowns of the plurality of selected teeth.

The step of generating the second three dimensional image of the root of the corresponding tooth or roots of the corresponding selected teeth comprises radiographically scanning or magnetically resonance scanning the root of the corresponding tooth or roots of the corresponding selected teeth.

In one embodiment the method further comprises the step of manufacturing an orthodontic appliance based on the composite image.

In one embodiment the step of manufacturing an orthodontic appliance based on the composite image comprises the step of robotically manufacturing the orthodontic appliance based on the composite image.

In one embodiment the method further comprises the step of manufacturing an orthodontic appliance based on the composite image using computer assisted manufacturing.

The illustrated embodiment of the invention also includes an apparatus comprising: means for generating a first three dimensional intra-oral image of the crown of a tooth or crowns of a plurality of selected teeth; means for generating a second three dimensional image of the root of the corresponding tooth or roots of the corresponding selected teeth; and means for compositing the first and second three dimensional images of the crown and root of the tooth or crowns and roots of the plurality of selected teeth to produce a composite image.

The means for generating the first three dimensional intra-oral image of the crown of the tooth or crowns of the plurality of selected teeth comprises a means for generating a first three dimensional intra-oral image using optical scanning, laser scanning, video scanning of crown of the tooth or crowns of the plurality of selected teeth.

The means for generating the first three dimensional intra-oral image of the crown of the tooth or crowns of the plurality of selected teeth comprises a means for nonradiographically scanning the crown of the tooth or crowns of the plurality of selected teeth.

The means for generating the second three dimensional image of the root of the corresponding tooth or roots of the corresponding selected teeth comprises a means for radiographically scanning or magnetically resonance scanning the root of the corresponding tooth or roots of the corresponding selected teeth.

The apparatus further comprising a means for manufacturing an orthodontic appliance based on the composite image.

The means for manufacturing an orthodontic appliance based on the composite image comprises a means for robotically manufacturing the orthodontic appliance based on the composite image.

The apparatus further comprises a means for manufacturing an orthodontic appliance based on the composite image using computer assisted manufacturing.

The illustrated embodiment of the invention also includes a computer-readable storage medium including instructions for controlling a computer system wherein the instructions when executed in the computer system control the computer system to: generate a first three dimensional intra-oral image of the crown of a tooth or crowns of a plurality of selected teeth; generate a second three dimensional image of the root of the corresponding tooth or roots of the corresponding selected teeth; and composite the first and second three dimensional images of the crown and root of the tooth or crowns and roots of the plurality of selected teeth to produce a composite image.

The instructions when executed in the computer system control the computer system to generate a first three dimensional intra-oral image using optical scanning, laser scanning, video scanning of crown of the tooth or crowns of the plurality of selected teeth.

The instructions when executed in the computer system control the computer system to nonradiographically scan the crown of the tooth or crowns of the plurality of selected teeth.

The instructions when executed in the computer system control the computer system to radiographically scan or magnetically resonance scan the root of the corresponding tooth or roots of the corresponding selected teeth.

The instructions when executed in the computer system control the computer system to manufacture an orthodontic appliance based on the composite image.

The instructions when executed in the computer system control the computer system to robotically manufacture the orthodontic appliance based on the composite image.

The instructions when executed in the computer system control the computer system to manufacture an orthodontic appliance based on the composite image using computer assisted manufacturing.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a conceptual diagram which outlines the method, apparatus and software product of the illustrated embodiment of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

The invention is directed to a method of taking an intra oral scan using light, laser, video, sound or any other nonradiographic method and “stitching” or superimposing it in three dimensions over a cone beam or other three dimensional x-ray based scan (cone beam, cat scan) or MRI, to gain the accuracy of the intra oral scan, but add the root position which is visible only in an x-ray based scan. The root position could be imaged with ultrasound as well.

The benefit of the illustrated embodiment of the invention is that the orthodontist can take an x-ray scan, which would not necessarily have to be high resolution and therefore could be low dose, or ultrasound scan, which would show the crown and the root of the teeth, and then add the crown of the tooth to the scan thru the intra-oral scan, which can be extremely accurate, to construct orthodontic appliances which have accurate three dimensional data on the root orientation of the tooth and of the orientation of the corresponding the crown of the tooth in three dimensions. The high definition intra-oral scan is superimposed over the crown of the x-ray or ultra sound scan, consequently gaining information to locate the root position and angulation in three dimensions.

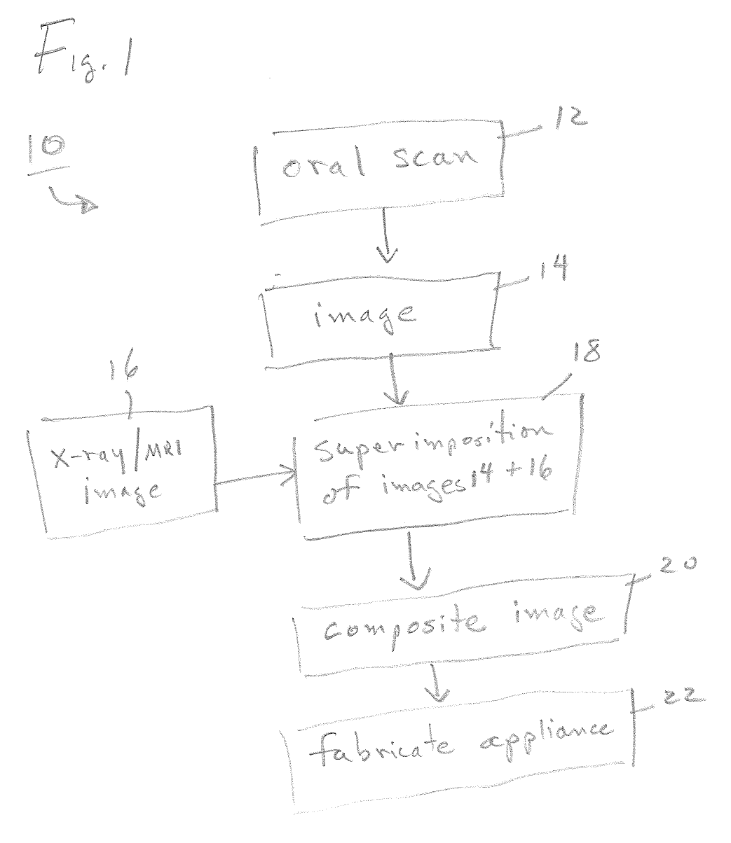

As diagrammatically shown in FIG. 1, the illustrated embodiment of the invention includes a software program 10 that takes as its input a conventional intra oral scan 12 using light, laser, video or any other nonradiographic method of generating an image of the teeth, which method now known or later devised, and then “stitching” or superimposing that nonradiographic image 14 in three dimensions over a conventional cone beam or other three dimensional x-ray based scan (cone beam, cat scan) or MRI image 16 in step 18. What results is a composite image 20 that shows a three dimensional image of the crown of the teeth with the high accuracy of the intra-oral scan from step 12 correlated to the three dimensional image of the root position from the radiographic image from step 16.

By having a three dimensional model of the tooth crown correlated with at least the three dimensional vector direction of the tooth's root in composite image 20, an orthodontist or an orthodontic laboratory can fabricate and install an appropriate brace, wire or other orthodontic appliance at step 22 that provides an optimum orthodontic correction to a desired dental end configuration.

The illustrated embodiment of the method includes the capability for a method of automated manufacturing or computer assisted manufacturing of the needed brace, wire or other orthodontic appliance for each situation at step 22 based on the composite image at step 20, which is reduced to a set of digital markers designating material crown and root positions and/or directions from which a set of machine instructions is generated at step 22 to fabricate the appliance.

The illustrated embodiment further includes an apparatus or system for generating the composite image and/or fabricating the brace, wire or other orthodontic appliance. The apparatus or system comprises a computer system with conventional image scanners as input devices and a computer controlled conventional robot as an output device.

The illustrated embodiment further includes a computer program stored on a medium including instructions for controlling a computer or processor to perform any one of the above methods.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments. For example, in addition to the illustrated usage in orthodontics, the invention can also be used to advantage in various applications in restorative dentistry.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method comprising:
generating a first three dimensional intra-oral image of the crown of a tooth or crowns of a plurality of selected teeth;
generating a second three dimensional image of the root of the corresponding tooth or roots of the corresponding selected teeth; and
compositing the first and second three dimensional images of the crown and root of the tooth or crowns and roots of the plurality of selected teeth to produce a composite image.

2. The method of claim 1 where generating the first three dimensional intra-oral image of the crown of the tooth or crowns of the plurality of selected teeth comprises generating a first three dimensional intra-oral image using optical scanning, laser scanning, video scanning of crown of the tooth or crowns of the plurality of selected teeth.

3. The method of claim 1 where generating the first three dimensional intra-oral image of the crown of the tooth or crowns of the plurality of selected teeth comprises nonradiographically scanning the crown of the tooth or crowns of the plurality of selected teeth.

4. The method of claim 1 where generating the second three dimensional image of the root of the corresponding tooth or roots of the corresponding selected teeth comprises radiographically scanning or magnetically resonance scanning the root of the corresponding tooth or roots of the corresponding selected teeth.

5. The method of claim 1 further comprising manufacturing an orthodontic appliance based on the composite image.

6. The method of claim 5 where manufacturing an orthodontic appliance based on the composite image comprises robotically manufacturing the orthodontic appliance based on the composite image.

7. The method of claim 1 further comprising manufacturing an orthodontic appliance based on the composite image using computer assisted manufacturing.

8. An apparatus comprising:
means for generating a first three dimensional intra-oral image of the crown of a tooth or crowns of a plurality of selected teeth;
means for generating a second three dimensional image of the root of the corresponding tooth or roots of the corresponding selected teeth; and
means for compositing the first and second three dimensional images of the crown and root of the tooth or crowns and roots of the plurality of selected teeth to produce a composite image.

9. The apparatus of claim 8 where the means for generating the first three dimensional intra-oral image of the crown of the tooth or crowns of the plurality of selected teeth comprises a means for generating a first three dimensional intra-oral image using optical scanning, laser scanning, video scanning of crown of the tooth or crowns of the plurality of selected teeth.

10. The apparatus of claim 8 where the means for generating the first three dimensional intra-oral image of the crown of the tooth or crowns of the plurality of selected teeth comprises a means for nonradiographically scanning the crown of the tooth or crowns of the plurality of selected teeth.

11. The apparatus of claim 8 where the means for generating the second three dimensional image of the root of the corresponding tooth or roots of the corresponding selected teeth comprises a means for radiographically scanning or magnetically resonance scanning the root of the corresponding tooth or roots of the corresponding selected teeth.

12. The apparatus of claim 8 further comprising a means for manufacturing an orthodontic appliance based on the composite image.

13. The apparatus of claim 12 where the means for manufacturing an orthodontic appliance based on the composite image comprises a means for robotically manufacturing the orthodontic appliance based on the composite image.

14. The apparatus of claim 1 further comprises a means for manufacturing an orthodontic appliance based on the composite image using computer assisted manufacturing.

15. A computer-readable storage medium including instructions for controlling a computer system wherein the instructions when executed in the computer system control the computer system to:
generate a first three dimensional intra-oral image of the crown of a tooth or crowns of a plurality of selected teeth;
generate a second three dimensional image of the root of the corresponding tooth or roots of the corresponding selected teeth; and
composite the first and second three dimensional images of the crown and root of the tooth or crowns and roots of the plurality of selected teeth to produce a composite image.

16. The computer-readable storage medium of claim 15 wherein the instructions when executed in the computer system control the computer system to generate a first three dimensional intra-oral image using optical scanning, laser scanning, video scanning of crown of the tooth or crowns of the plurality of selected teeth.

17. The computer-readable storage medium of claim 15 wherein the instructions when executed in the computer system control the computer system to nonradiographically scan the crown of the tooth or crowns of the plurality of selected teeth.

18. The computer-readable storage medium of claim 15 wherein the instructions when executed in the computer system control the computer system to radiographically scan or magnetically resonance scan the root of the corresponding tooth or roots of the corresponding selected teeth.

19. The computer-readable storage medium of claim 15 wherein the instructions when executed in the computer system control the computer system to manufacture an orthodontic appliance based on the composite image.

20. The computer-readable storage medium of claim 19 wherein the instructions when executed in the computer system control the computer system to robotically manufacture the orthodontic appliance based on the composite image.

21. The computer-readable storage medium of claim 15 wherein the instructions when executed in the computer system control the computer system to manufacture an orthodontic appliance based on the composite image using computer assisted manufacturing.
